(19) United States
(12) Patent Application Publication
(10) Pub. No.: US 2004/0065342 A1
(43) Pub. Date: Apr. 8, 2004

(54) Dental floss dispenser and pen

(76) Inventor: Thomas Sherman, Phoenix, AZ (US)

Correspondence Address: The Halvorson Law Firm, P.C., 405 W. Southern Ave., Suite 1, Tempe, AZ, 85282, US

(21) Appl. No.: 10/265,528

(22) Filed: Oct. 4, 2002

(51) Int. Cl. A61C 15/00

(52) U.S. Cl. 132/325

(57) ABSTRACT

Described is a combination writing instrument and dental floss dispenser. The dental floss dispenser includes a floss wrapped spool and floss dispensing cap.

### FIELD OF THE INVENTION

The present invention relates to the field of writing devices with additional uses. More specifically, the present invention relates to pens that include a dental floss dispensing mechanism in the pen body.

### BACKGROUND

It is common knowledge that flossing teeth after eating is a benefit to oral hygiene. However, busy people, such as business people, eat at least one meal away from home (where people normally keep their floss dispensers). Thus, these people do not have the ability to floss until they return home.

The prior art demonstrates that dental floss dispensers have been incorporated into a variety of different devices, ranging from toothbrush handles, pen bodies, dental instruments, and credit card sized packages. However, people have not taken full advantage of these devices.

Thus, there is a need for improved devices that dispense dental floss and is conveniently and commonly carried by an individual.

### SUMMARY OF INVENTION

It is an object of the present invention to provide a convenient dental floss dispensing device.

It is another object of the present invention to provide a dental floss dispensing device that is incorporated into a writing instrument, such as a pen.

It is a further object of the present invention to provide a dental floss dispensing device, which is incorporated into a writing instrument, and that is reusable/refillable.

It is still another object of the present invention to provide a dental floss dispensing device, which is incorporated into a writing instrument, that has a novel dispensing mechanism.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112,paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1 is one view of the present invention (with caps on both ends).

FIG. 2 is a second view of the present invention, exploded with caps off both ends).

FIG. 3 is an exploded view of the present invention, clearly illustrating all parts.

FIG. 4 is a sectional view along line 3 of FIG. 1.

### DETAILED DESCRIPTION OF PREFERRED EMBODIMENTS

The present invention is useful in that it provides an easy and convenient dental floss dispense that is integrated into a writing instrument.

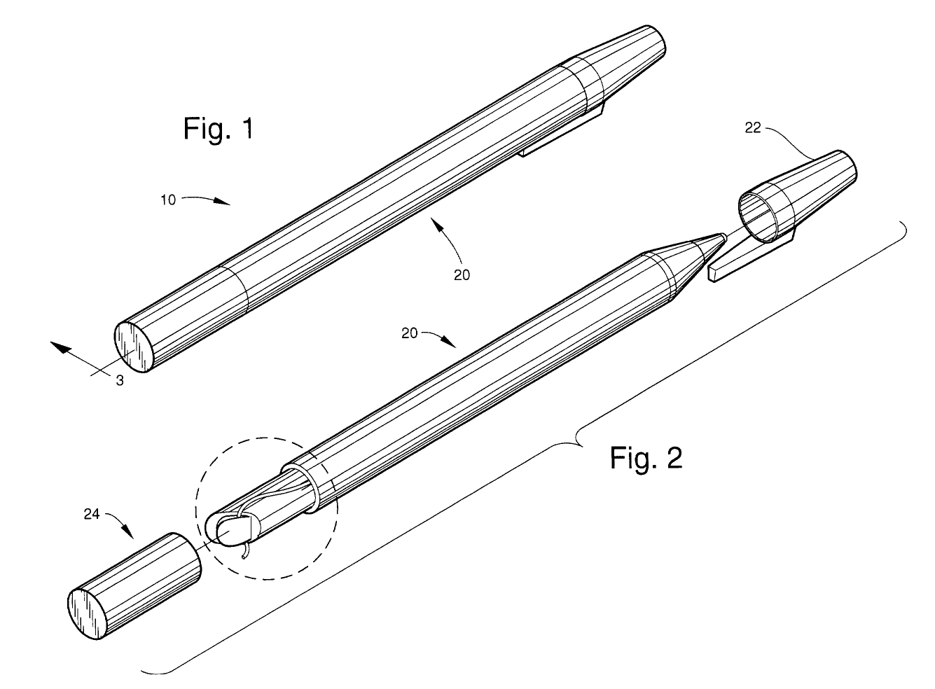

The present invention 10, as illustrated in FIGS. 1-4, is a single device having a main body 20, a first cap 22 and a second cap 24. The first cap 22 is typical of caps found on writing instruments and serves to cover the writing portion of the device 10. The second cap 24 is designed to cover the dental floss dispensing portion of the device 10 and is designed, in the preferred embodiment, to look substantially similar to the main body 20 of the device 10. In the preferred embodiment the second cap is a short hollow tube 25 that is closed by a partition 26 located at one end. The outer diameter of the second cap 24 substantially matches the outer diameter of the main body 20. Other shapes for the second cap 24, however, may be used and still fall within the scope of the present invention.

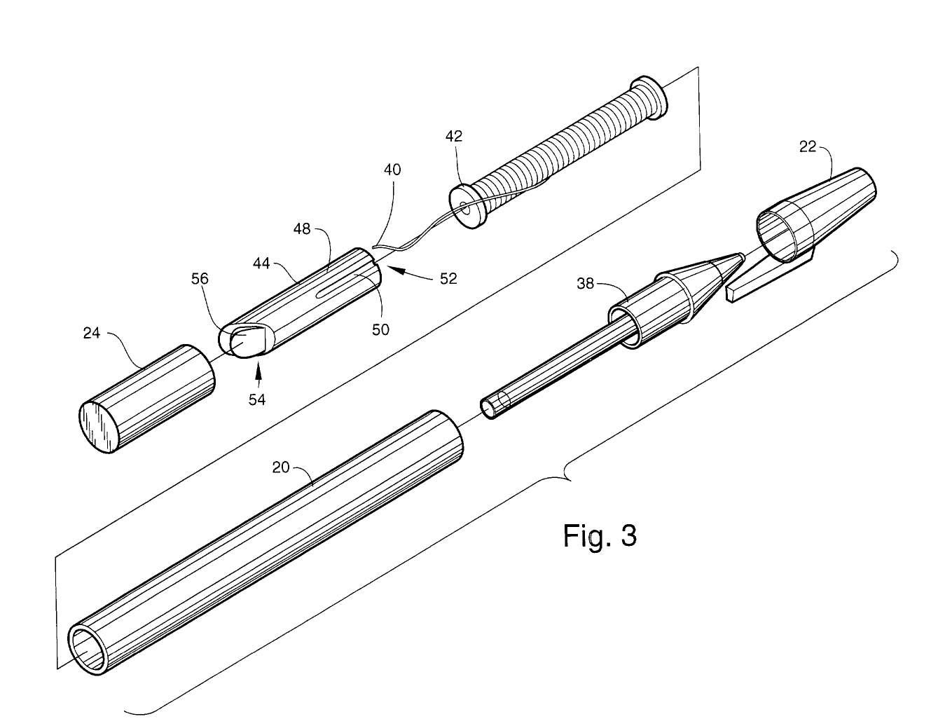

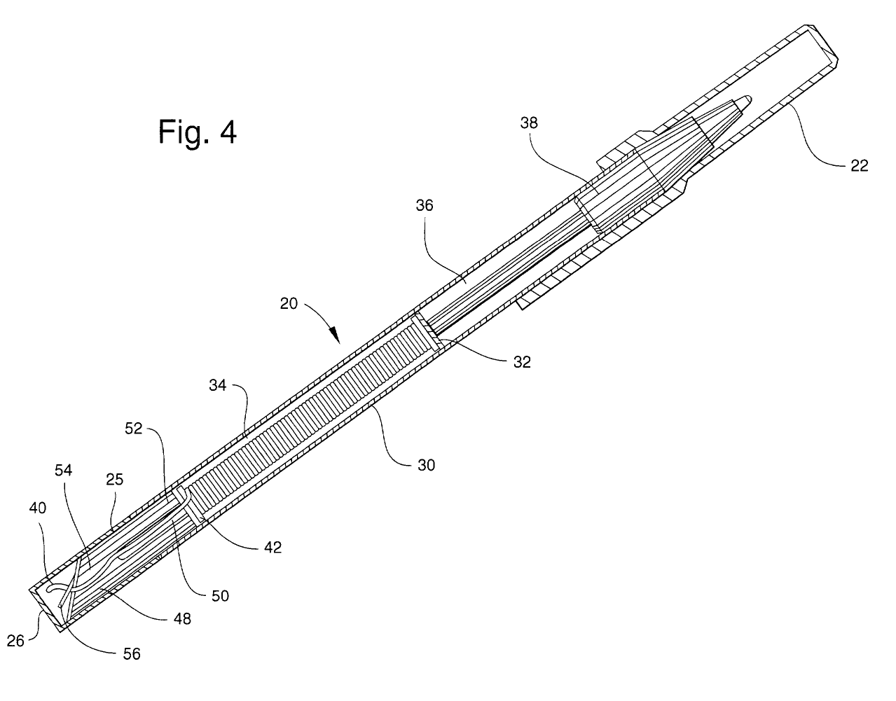

As illustrated in more clearly in FIGS. 3 and 4, the body 20 is a substantially hollow tube 30 that includes a separation partition 32 located approximately mid-way in the tube 30. The separation partition 32 is a solid partition in the preferred embodiment, but may be a ring or other shape and still fall within the scope of the present invention. The separation partition 32 serves to physically separate the dental floss dispensing portion 34 from the writing instrument portion 36. A solid physical separation serves to prevent unwanted ink contamination of the dental floss. Additionally, differing inner diameters for the two portions 34 and 36 may be used in place of the separation partition 32 and still fall within the scope of the present invention.

A shortened writing instrument 38, that is typical of commercial writing instruments, with the exception of a shortened ink barrel, is included in the writing instrument portion 36 of the present invention.

A length of dental floss 40 is wrapped around a floss spool 42. The wrapped floss spool is inserted into the floss dispensing portion 34 of the main body 20. A floss dispensing cap 44 is inserted into the open end of the floss dispensing portion 34 to keep the wrapped floss spool in place and to aid in dispensing the dental floss 40. The floss dispensing cap 44 is a substantially cylindrical body 48 having a dispensing channel 50 located near a first end 52. A second end 54 of the floss dispensing cap 44 is preferentially angled relative to the longitudinal axis of the floss dispensing cap 44. However, the second end 54 may have any angle relative to the longitudinal axis of the floss dispensing cap 44 and still fall within the scope of the present invention.

There is a floss cutting tang 56 that is attached to the second end 54 of the floss dispensing cap 44 and is used to sever a length of floss 40 after it has been dispensed from the spool.

In an alternate embodiment, the floss dispensing cap 44 may be locked into the main body 20 by means of a locking channel and lock pip. In one version, the locking channel is formed in an inside surface of the tube 30 and extends inward from the open end of the floss dispensing portion 34 and forms a substantially L shape (or other locking suitable shape). In this version, the lock pip is formed on an outer surface of the floss dispensing cap 44 and is sized to fit within the locking channel. The floss dispensing cap 44 is locked into place by inserting it into the main body and rotating the pip into the lower leg of the L-shape. In another version of the locking mechanism, the locking channel may be formed on the outer surface of the floss dispensing cap 44 and the locking pip formed on the inner surface of the main body 20. Locking the floss dispensing cap 44 is as described above.

In use, the wrapped floss spool 42 is inserted into the floss dispensing portion 34 of the main body 20. A short length of floss 40 is unwrapped from the floss spool 42 and allowed to extend beyond the open end of the floss dispensing portion 34. The floss dispensing cap 44 is insterted into the open end of the floss dispensing portion 34, with the short length of floss 40 being placed within the dispensing channel 50. Floss 40 may then be easily dispensed by merely pulling on the short length of 40 and terminated by pulling across the floss cutting tang 56. The severed piece of floss may then be used for oral hygiene and a new short length is left for easy further floss dispensing. When not in use, the second cap 24 is placed over the floss dispensing cap 44 to prevent unwanted contamination of the floss dispensing mechanism.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1) A combination writing instrument and dental floss dispenser comprising
a) A main body comprising a hollow tube having a separation partition that defines a writing instrument portion and a dental floss dispensing portion;
b) A writing instrument contained within the writing instrument portion;
c) A floss spool, having dental floss wrapped thereon, contained within the dental floss dispensing portion; and
d) A dental floss dispensing cap having dispensing channel located near a first end and floss cutting tang located on a second end, said dental floss dispensing cap contained by an open end of the dental floss dispensing portion.

2) The combination writing instrument and dental floss dispenser according to claim 1 in combination with first and second caps, said first cap removably attachable to cover an end of the writing portion and said second cap removably attachable to cover that dental floss dispensing cap.

3) The combination writing instrument and dental floss dispenser according to claim 1 wherein the separation partition in the main body is selected from the group comprising a solid partition, a ring partition and a mesh partition.

4) The combination writing instrument and dental floss dispenser according to claim 2 wherein the separation partition in the main body is selected from the group comprising a solid partition, a ring partition and a mesh partition.

5) The combination writing instrument and dental floss dispenser according to claim 1 wherein the second end of the floss dispensing cap is angled relative to the longitudinal axis of the floss dispensing cap.

6) The combination writing instrument and dental floss dispenser according to claim 3 wherein the second end of the floss dispensing cap is angled relative to the longitudinal axis of the floss dispensing cap.

7) The combination writing instrument and dental floss dispenser according to claim 4 wherein the second end of the floss dispensing cap is angled relative to the longitudinal axis of the floss dispensing cap.

8) The combination writing instrument and dental floss dispenser according to claim 1 further comprising a locking channel located in an inside surface of the floss dispensing portion of the main body and a lock pip formed on an outer surface of the floss dispensing cap, where the lock pip and lock channel work together to removably lock the floss dispensing cap to the main body.

9) The combination writing instrument and dental floss dispenser according to claim 1 further comprising a lock pip located in an inside surface of the floss dispensing portion of the main body and a locking channel formed on an outer surface of the floss dispensing cap, where the lock pip and lock channel work together to removably lock the floss dispensing cap to the main body.

10) The combination writing instrument and dental floss dispenser according to claim 8 wherein the locking channel is substantially L-shaped.

11) The combination writing instrument and dental floss dispenser according to claim 9 wherein the locking channel is substantially L-shaped.
